(19) United States
(12) Patent Application Publication
(10) Pub. No.: US 2008/0052838 A1
(43) Pub. Date: Mar. 6, 2008

(54) Method for leaching and brightening kaolin clay and other minerals

(76) Inventors: Qiang Huang, Andover, MA (US); Ranganammar Goda, Hampstead, NH (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 11/894,243

(22) Filed: Aug. 20, 2007

Related U.S. Application Data
(60) Provisional application No. 60/841,948, filed on Sep. 1, 2006.

(51) Int. Cl. C04B 33/04

(52) U.S. Cl. 8/107

(57) ABSTRACT

A method for brightening kaolin clays and other minerals by combining sodium borohydride, sodium hydroxide and sodium bisulfite, in a chemical mixer and adding the output of the chemical mixer to the slurry of kaolin clays.

This application claims the benefit of priority under 35 U.S.C. §119(e) of U.S. Provisional Patent Application No. 60/841,948 filed on Sep. 1, 2006.

### BACKGROUND

The invention relates to improved methods for bleaching kaolin clay and other minerals using reductive bleaching.

Kaolin clay is useful in several industries, including paper, porcelain and fine china. For example, the paper industry utilizes large amounts of kaolin clay as a filler or coating for paper and paper board. A very white, bright product is required for this use. Raw kaolin usually has a brightness rating of only about 75-80% ISO relative to the standard magnesium oxide (value of 100).

Bleaching agents can improve brightness and reduce color in kaolin. The cost of bleaching chemicals for a single large kaolin plant can exceed several million dollars per year. Thus, it would be highly desirable to develop processes for bleaching minerals, particularly kaolin, which require reduced bleach consumption. Various methods have been employed to bleach kaolin clay. Some early work involved oxidative bleaching with ozone or hydrogen peroxide. Other processes have involved preparing a kaolin slurry in water (e.g., to provide about 20-25% solids), adjusting the pH to about 3-4.5 with a suitable acid, and adding sodium dithionite (also known as sodium hydrosulfite, Na₂S₂O₄) to the slurry. However, sodium dithionite is unstable in acidic solutions, and even with excess dithionite, bleaching is effective only for a very limited time, e.g., about one hour. Further, it was shown that as the dithionite became exhausted, aerobic oxygen again slowly re-oxidized the remaining iron, so that at least some of the effectiveness of the dithionite was wasted. Clay can be bleached with dithionite generated in situ from borohydride solution and a sulfur source, as disclosed, e.g., in U.S. Pat. No. 3,937,632. However, all of the known processes require at least stoichiometric amounts of the sulfur source.

Still, it remains desirable to develop improved, alternate processes for bleaching minerals, particularly kaolin clay. It would be highly desirable to develop processes that would offer improved economics to industry and to end-user consumers.

### STATEMENT OF THE INVENTION

This invention is directed to a method for brightening kaolin clays and other minerals. The method comprises combining: (i) an aqueous solution comprising sodium borohydride and sodium hydroxide; and (ii) an aqueous solution comprising sodium bisulfite, in a chemical mixer and adding output of the chemical mixer to slurry of kaolin clays. The ratio of (moles bisulfite−moles hydroxide)/moles borohydride is no more than 7.8.

### DETAILED DESCRIPTION OF THE INVENTION

All percentages are expressed as weight percentages, unless specified otherwise. The term “pre-mix” refers to a kaolin brightening process in which borohydride and bisulfite are mixed prior to addition to the clay.

Dithionite ion can be produced by the reaction between bisulfite and borohydride ions, according to the following theoretical equation:

BH₄⁻+8 HSO₃⁻+H⁺→4 S₂O₄⁻²+B(OH)₃+5H₂O

The yield is somewhat less than 100% due to competing reactions, including that of borohydride with water, but is most often better than 85%. Since the exact mechanism of the reaction has not been fully characterized, this invention is not limited to reduction by dithionite ion, and other species present in the reaction mixture also may act as reducing agents. When the amount of bisulfite is below 8 moles per mole of borohydride, the theoretical reaction cannot proceed to completion. Without wishing to be bound by theory, it is believed that use of less than the theoretical amount of bisulfite results in a mixture containing hydrosulfite, borohydride, and possibly other species.

In a preferred embodiment of the invention, borohydride is added in the form of an aqueous solution containing sodium borohydride and sodium hydroxide. In this embodiment, some of the bisulfite is consumed in a neutralization reaction with the hydroxide ion. In some applications, hydroxide ion present in borohydride solutions is neutralized by acid added to the bisulfite solution. In such a case, to the extent that the hydroxide initially present in the borohydride solution has been neutralized, it will not consume bisulfite, and will not be included in the ratio calculation. As described above, the theoretical reaction of borohydride and bisulfite requires 8 moles of unconsumed bisulfite per mole of borohydride, i.e., the ratio (moles bisulfite−moles hydroxide)/moles borohydride is at least 8. The present invention uses a ratio no more than 7.8. In one embodiment of the invention, the ratio is no more than 7.5, alternatively no more than 7, alternatively no more than 6.8, alternatively no more than 6. In one embodiment of the invention, the ratio is at least 1, alternatively at least 2, alternatively at least 3, alternatively at least 5. Use of any ratio lower than the theoretical value of 8 produces cost savings from decreased usage of bisulfite, relative to the conventional stoichiometric process. The data provided below in the Example demonstrate, unexpectedly, that these cost savings can be achieved without sacrificing performance.

The ratio (moles bisulfite−moles hydroxide)/moles borohydride can be equal to zero, as shown in the Example. In this case, some bisulfite is combined with the borohydride solution, but it is completely neutralized by the hydroxide present in the borohydride solution, so that the numerator of the ratio, and thus the entire ratio, is zero. In the method of this invention, preferably at least 0.05% of bisulfite, based on the weight of dry kaolin, is added to the kaolin slurry. In one embodiment of the invention, at least 0.1% of bisulfite is added.

In one embodiment of the invention, bisulfite is generated by combining water and sodium metabisulfite, Na₂S₂O₅. The aqueous sodium bisulfite preferably is about 20% to about 45% active by weight. A preferred solution containing borohydride for use in the method of this invention comprises about 1% to about 36% active sodium borohydride and about 30 to about 45% NaOH or Na₂CO₃ (also known as soda ash), all by weight. In one embodiment of the invention, the borohydride solution contains from 10% to 20% sodium borohydride and 35% to 42% NaOH. A particularly preferred borohydride solution comprising 12% active sodium borohydride and 40% NaOH is commercially available from Rohm and Haas Company under the trademark ACUBRIGHT™ solution. For example, 100 g of ACUBRIGHT™ solution. contains 12 g sodium borohydride, 40 g NaOH, and 48 g H₂O. For this sodium borohydride solution, the theoretical equation for reaction with bisulfite is as follows

[NaBH₄+3.2 NaOH]+11.2 NaHSO₃→4 Na₂S₂O₄+(NaBO₂+3.2 Na₂SO₃+9.2H₂O)

### There are 3.2 moles of hydroxide per mole of borohydride, and the hydroxide has not been neutralized with a mineral acid, so that the ratio of bisulfite unconsumed by hydroxide to borohydride is (11.2−3.2)/1=8.0, i.e., the theoretical ratio.

The borohydride solution and the bisulfite solution are mixed in a chemical mixer. The output of the mixer is known as “premix” solution. Preferably, the mixer is an in-line static mixer. Typical in-line static mixers have from 2 to 24 internal elements, preferably from 2 to 6 internal elements. The number of elements, the diameter of the mixer and the length of piping required to achieve good mixing, i.e., to produce a substantially homogeneous mixture, can be determined easily from the flow parameters and fluid properties of each particular system. For example, in one method dye is added to one of the solutions and good mixing is assessed by visible determination that the color of the output is uniform. In another method, the pH of the kaolin slurry after addition of the mixed borohydride and bisulfite solutions is measured; a stable pH value is an indication of good mixing, as are consistent bleaching results. The pH of premix solution varies from 5 to 12. Preferably, if mixing is insufficient, the borohydride and bisulfite solutions are diluted. Preferably, the borohydride and bisulfite solutions are mixed at a temperature in the range from 4° C. to 50° C., more preferably from 10° C. to 35° C.

Preferably, the mixed borohydride and bisulfite solutions are added to the clay slurry directly, or by storing the output in a vessel for later addition to the clay slurry. In one preferred embodiment, the output of the mixer is added to the clay slurry within 12 hours of mixing, more preferably within 6 hours, more preferably within 3 hours, more preferably within 1 hour, and most preferably within ½ hour of mixing. In another preferred embodiment, the mixer output is added directly through piping which carries the output to the kaolin slurry in less than 15 minutes, more preferably less than 10 minutes, and most preferably less than 5 minutes. Preferably, the amount of borohydride added to the kaolin slurry, measured as the percentage of sodium borohydride relative to the dried clay content of the kaolin slurry, is at least 0.0015%, more preferably at least 0.003%, and most preferably at least 0.004%. Preferably, the amount of borohydride added to the kaolin slurry, measured as the percentage of sodium borohydride relative to dried kaolin, is no more than 0.12%, more preferably no more than 0.09%, and most preferably no more than 0.066%. In a preferred embodiment of the invention, a 12% aqueous sodium borohydride solution is used, e.g., ACUBRIGHT™ solution. In this embodiment, the weight of the solution used, measured as a percentage of the dry clay, is at least 0.025%, more preferably at least 0.033%, and most preferably at least 0.042%. Preferably, the weight of solution used, measured as a percentage of the dry clay, is no more than 1%, more preferably no more than 0.75%, and most preferably no more than 0.55%.

Methods of the present invention may be carried out effectively under alkaline pH reaction conditions such as pH 7-10. However, it is more preferable to carry out such methods at an acidic pH, resulting in particularly enhanced bleaching of the desired material.

Thus, in preferred embodiments of the present invention, the admixture of the material to be bleached and bleaching agents is acidic, particularly mildly acidic such as a pH no more acidic than 0.5 or 1, but no more than 7. A pH range of about 1 to 5, more typically about 2 to 4.5, is generally preferred. A pH range of about 2.5 to 4 is particularly preferred.

The pH of the material to be bleached is typically adjusted using a dilute acid, preferably dilute sulfuric acid, e.g., 10% H₂SO₄. Other acids such as HCl, methanesulfonic acid and the like, as well as other chemicals, e.g. aluminum sulfate, also are suitable for such a pH adjustment.

### EXAMPLE

### Laboratory Studies

A kaolin sample from Georgia was used for the study. Pre-mix and hydrosulfite bleaching studies were conducted on this sample. Pre-mix was performed at different bisulfite-to-borohydride molar ratios as listed in Table I. The studies were performed at 25.63% solids, 55° C. and a retention time of 20 minutes. The initial clay brightness was 86.2% ISO. Table I shows the result of a comparison between the hydrosulfite (“hydro”) and pre-mix processes at various molar ratios, using ACUBRIGHT™ solution (“AB”), with amounts listed in kg/1000 kg (kg/t, based on dry clay). The bleaching responses of the hydrosulfite and pre-mix processes were similar at the molar ratios ((moles bisulfite−moles hydroxide)/moles borohydride)) studied from 0 to 12.

TABLE I
Laboratory bleaching response of hydro and pre-mix processes.

| | Hydro, | | | *HSO₃⁻ | | | |
|---|---|---|---|---|---|---|---|
| | kg/t | | | to AB | | | |
| | active | AB | HSO₃⁻ | molar | Alum | kaolin | Brightness |
| Sample | basis | kg/t | kg/t | ratio | kg/t | pH | % ISO |
| As is | 0 | 0 | 0 | — | 8.6 | — | 86.2 |
| hydro | 1.75 | 0 | — | — | 8.6 | 3.76 | 88.1 |
| hydro | 2.25 | 0 | — | — | 8.6 | 3.77 | 88.2 |
| Premix | 0 | 0.55 | 0.55 | 0:1 | 8.65 | 3.85 | 88.2 |
| Premix | 0 | 0.55 | 1.1 | 3:1 | 8.65 | 3.80 | 88.2 |
| Premix | 0 | 0.55 | 1.65 | 6:1 | 8.65 | 3.87 | 88.2 |
| Premix | 0 | 0.55 | 2.04 | 8:1 | 8.65 | 3.89 | 88.1 |
| Premix | 0 | 0.55 | 2.75 | 12:1 | 8.6 | 3.87 | 88.2 |

Leaching conditions: 55° C., 20 minutes, as is solids (25.63%), clay pH was adjusted with alum to 3.8.
*Note: Molar ratio = (Moles of bisulfite-Moles of hydroxide)/Moles of borohydride

1. A method for leaching and brightening kaolin clays; said method comprising combining: (i) an aqueous solution comprising sodium borohydride and sodium hydroxide; and (ii) an aqueous solution comprising sodium bisulfite, in a chemical mixer and adding output of the chemical mixer to an aqueous slurry of kaolin clay;
wherein a ratio of (moles bisulfite−moles hydroxide)/moles borohydride is no more than 7.8.

2. The method of claim 1 in which at least 0.05% of bisulfite, based on weight of dry kaolin, is added to the kaolin slurry

3. The method of claim 2 in which said ratio is from 0 to 7.5.

4. The method of claim 3 in which the output of the chemical mixer is added to the kaolin slurry within 12 hours of mixing.

5. The method of claim 4 in which said ratio is from 3 to 7.5.

6. The method of claim 5 in which the output of the chemical mixer is added to the kaolin slurry less than 15 minutes after mixing.

7. The method of claim 6 in which the output of the chemical mixer is substantially homogeneous prior to addition to the kaolin slurry.

8. The method of claim 7 in which sodium borohydride is added in an amount from 0.0015% to 0.12%, based on dry kaolin.

9. The method of claim 8 in which an admixture of the aqueous slurry of kaolin clay and the output of the chemical mixer has a pH range from 1 to 10.

10. The method of claim 9 in which said pH range is from 1 to 5.
